(19) United States
(12) Patent Application Publication
(10) Pub. No.: US 2011/0059414 A1
(43) Pub. Date: Mar. 10, 2011

(54) ORTHODONTIC BRACKET

(75) Inventor: Markus Johannes Hirsch, Klagenfurt (AT)

(73) Assignee: PBD, Patent & Business Development AG, Zug (CH)

(21) Appl. No.: 12/736,133

(22) PCT Filed: Mar. 16, 2009
(86) PCT No.: PCT/AT2009/000109

§ 371 Date: Nov. 2, 2010

(30) Foreign Application Priority Data
Mar. 14, 2008 (AT) A 412/2008

(51) Int. Cl. A61C 7/14

(52) U.S. Cl. 433/11

(57) ABSTRACT

The invention relates to an orthodontic component (1), in particular a bracket, with a main body (2) comprising a visible surface (3), a base surface (4) spaced at a distance apart from it and side faces (5 to 8) extending in between. A groove-shaped retaining slot (11) is provided in the main body (2) for accommodating a clamping wire (12) with at least one retaining means (17) for the clamping wire (12) extending into the retaining slot (11). The retaining means (17) is provided in the form of a catch projection (20) formed by providing a longitudinal slot (21) in the main body (2). The longitudinal slot (21) extends from a side wall (22) of the retaining slot (11) into the main body (2), thereby resulting in the elastically deformable catch projection (20).

The invention relates to an orthodontic component, in particular a bracket, of the type described in claim 1.

Patent specification WO 2005/044131 A1 discloses an orthodontic component with a main body, in which a groove-shaped retaining slot extends from its visible surface in order to retain a clamping wire. The retaining slot extends from the visible surface into the main body in the direction towards the base surface. In the region of the visible surface, the retaining slot has a narrower region formed by projections. In order to insert the clamping wire in the retaining slot, the two hook parts widen in the transition region down to the base part, thereby enabling the clamping wire to be inserted. This causes the main body of the orthodontic component to deform.

Another orthodontic component is disclosed in patent specification U.S. Pat. No. 5,174,754 A, comprising a base or foot part and hook parts. The retaining slot for the clamping wire is disposed in the region of the hook parts. Retaining arms project out into the region of the visible surface, which prevent the retaining wire from sliding out of the retaining slot. In order to insert the clamping wire, the hook parts are each resiliently connected to the base or foot part by a cut-out (20) disposed between them and the latter. During the movement which occurs during insertion, the two hook parts flex apart from one another in their entirety, thereby enabling the clamping wire to be inserted in the retaining slot.

Another orthodontic component is known from patent specification DE 10 2004 016 317 B4.It comprises a foot part, with base parts disposed on it as well as an insert part inserted between them. The two base parts are connected to the region of the foot part where a slot is provided so that they are able to pivot. This makes it easier to bend open the bracket and thus make the retaining slot wider. The base part is made from a shape memory plastic. Shape memory plastics have a property whereby they return to a predefined shape from a temporary shape due to the effect of an external stimulus, such as heat or UV light. Accordingly, the base parts can be prefabricated in their widened position in which the clamping wire can be easily inserted. Once the clamping wire has been fitted, the base parts deform towards one another due to the effect of the external stimulus, thereby making the opening width of the retaining slot smaller again so that the clamping wire is retained in the retaining slot.

Finally, patent specification DE 196 18 364 A1 discloses an orthodontic bracket comprising a foot part and a retaining and guide part disposed on it. A slot is provided in the guide part as a means of retaining an arch wire. Disposed in the upper region of the slot of the retaining and guide part are separate projections, which are made from a second plastic material different from the plastic of the bracket. This makes it more difficult for a projection to be sheared off by the arch wire than would otherwise be the case if it were injection molded simultaneously from the same material as that used for the bracket. The two projections bound the slot from either side and project into in order to retain the arch wire.

The underlying objective of this invention is to propose a self-alloying orthodontic component which has a stable and virtually non-deformable main body, whereby the clamping wire can be inserted as easily as possible but nevertheless ensures that the clamping wire is securely retained in the retaining slot.

This objective is achieved by the invention due to the features defined in claim 1. The surprising advantage obtained as a result of the features defined in the characterizing part of claim 1 is that a more stable main body is obtained in the region of the foot or base part as well as the retaining part, which is virtually non-deformable and intrinsically stable. A catch projection is provided, purely as a means of inserting the clamping wire and retaining it in the retaining slot, which is disposed on the main body so that it is elastically deformable relative to it. This catch projection can therefore be made from the same material as the main body without having to provide additional components. Due to the fact that the catch projection is formed by additionally providing a longitudinal slot in the region of the retaining slot, there is no need for the main body formed by the base part and retaining part to be deformed at all to permit the movement by which the clamping wire is inserted in the retaining slot. Accordingly, whilst only light forces are needed, the clamping wire is reliably retained in the retaining slot. By selecting appropriate dimensions for the cross-section of the retaining slot and the cross-section of the clamping wire, what might be referred to as an active self-alloying bracket can be obtained. Relatively light forces are needed to remove the clamping wire in that it can be pulled in the direction of its longitudinal extension out of the retaining slot. Consequently, the clamping wire can be removed from the retaining slot without it being necessary for the main body as a whole and also the catch projections to be deformed. Due to the relatively small size of the catch projections which have to be deformed, a higher overall strength or stability of the component as a whole can be obtained, which also lengthens the time during which the component can be worn.

Also of advantage is another embodiment defined in claim 2 because a shorter height of the orthodontic component can be obtained, requiring the smallest amount of space or room.

Another embodiment defined in claim 3 is of advantage because the clamping wire can be retained continuously across the longitudinal extension of the orthodontic component, thereby enabling even higher shearing forces to be absorbed. Furthermore, the risk of parts of the catch projections flexing down or shearing off is prevented.

The embodiment defined in claim 4 permits an easy movement to insert the clamping wire in the retaining slot on the one hand and ensures sufficient stability in terms of retaining the clamping wire in its position inserted in the retaining slot on the other hand. The clamping wire merely has to be inserted as the catch or catch projections are elastically deformed and no other separate aid or additional components are needed to manipulate it.

Based on another embodiment defined in claim 5, a better distribution of force is obtained for a longer period of time between the clamping wire and catch projection. Forces directing the clamping wire can therefore be transmitted more effectively via the orthodontic component to the tooth.

Also of advantage is another embodiment defined in claim 6 because the overall strength of the orthodontic component remains essentially unaffected but there is still sufficient room for the movement of the catch projections which has to be performed during the insertion operation.

The advantage of the embodiment defined in claim 7 is that the movement needed to insert the clamping wire is made easier on the one hand and the clamping wire is prevented from slipping out of the retaining slot by the catch projection or projections when subjected to opposing forces on the other hand.

Due to the embodiment defined in claim 8, a predefined deformation range is fixed between the catch projection and main body and as the catch projections are deformed, the material can not be subjected to excessive stress during the deformation movement.

As a result of the embodiment defined in claim 9, shorter displacement distances of the individual catch projections are needed but the clamping wire is nevertheless securely retained in the retaining slot.

Other advantageous embodiments are defined in claims 10 and 11.

Due to the choice of plastic defined in claims 12 and 13, no changes can occur to the state of the material during use, especially in body cavities such as the mouth, for example. Due to the use of modern plastics, a bracket of this type has hardness properties comparable with aluminum oxide components or similar. Due to the cross-linking of the plastic, subsequent alteration of the plastic is no longer possible and if polyurethane is used, there will be no effects which might be harmful to humans, and polyurethane is also resistant to attack by different fluids which can occur in the mouth, for example.

Finally, good optical properties of the orthodontic component can be obtained, in particular transparency of the basic color of the tooth, due to the design of embodiment of the orthodontic component defined in claim 14.

The invention will be explained in more detail below with reference to examples of embodiments illustrated in the appended drawings.

Of these:

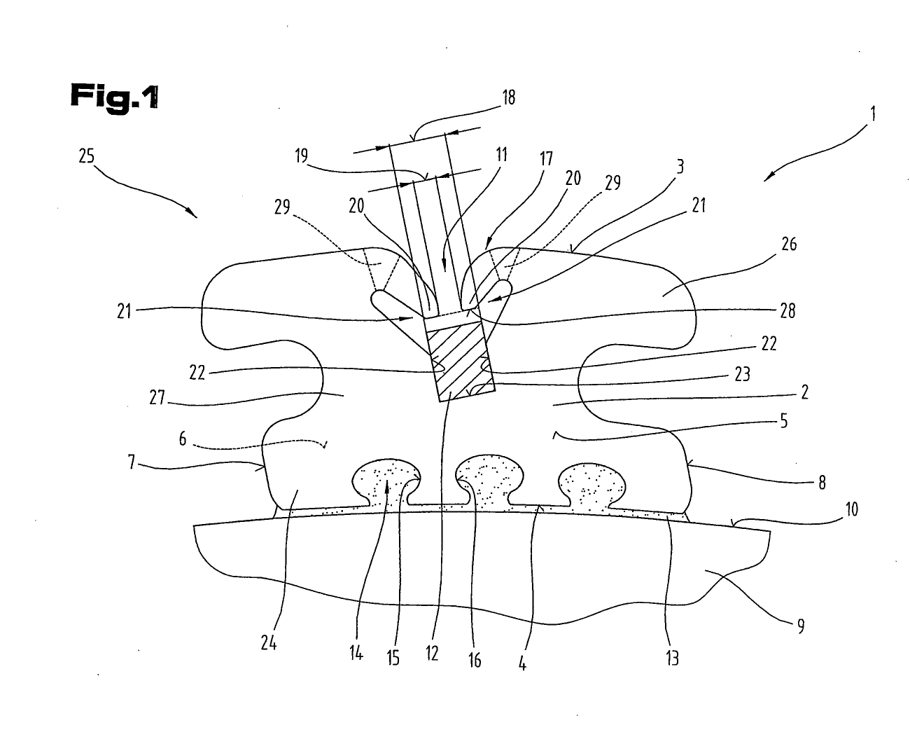

FIG. 1 is a simplified, schematic diagram showing a front view of an orthodontic component proposed by the invention;

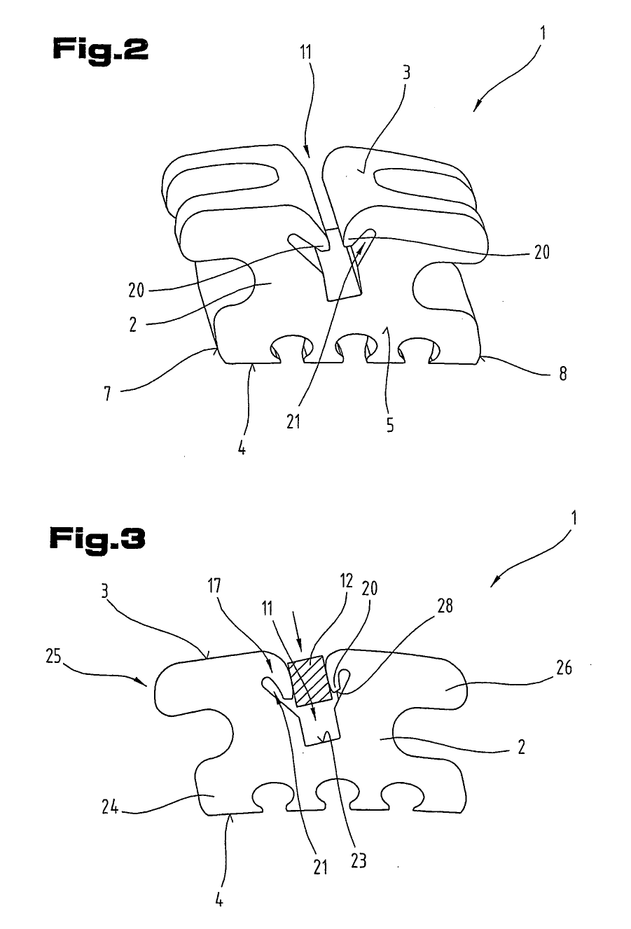

FIG. 2 is a simplified diagram showing the orthodontic component illustrated in FIG. 1;

FIG. 3 is a simplified, schematic diagram showing a front view of the orthodontic component illustrated in FIGS. 1 and 2 during the operation of inserting the clamping wire in the retaining slot;

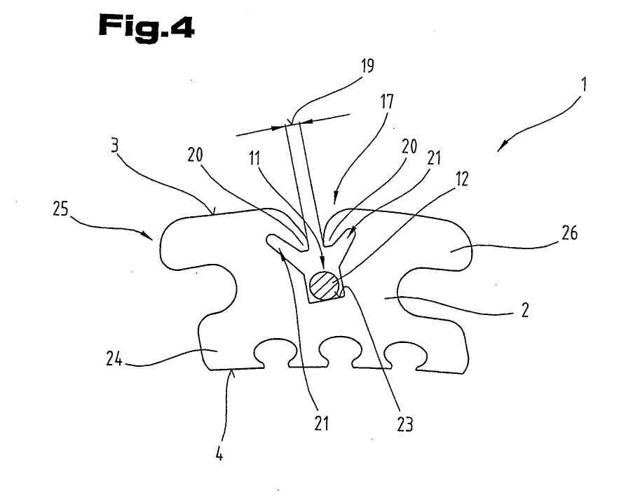

FIG. 4 shows the orthodontic component illustrated in FIG. 1 but with a different cross-section of the clamping wire.

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc., relate to the drawing specifically being described and can be transposed in terms of meaning to a new position when another position is being described. Individual features or combinations of features from the different embodiments illustrated and described may be construed as independent inventive solutions or solutions proposed by the invention in their own right.

All the figures, relating to ranges of values in the description should be construed as meaning that they include any and all part-ranges, in which case, for example, the range of 1 to 10 should be understood as including all part-ranges starting from the lower limit of 1 to the upper limit of 10, i.e. all part-ranges starting with a lower limit of 1 or more and ending with an upper limit of 10 or less, e.g. 1 to 1.7, or 3.2 to 8.1 or 5.5 to 10.

FIGS. 1 to 3 provide simplified diagrams of an orthodontic component 1 and it should be pointed out that the illustrated contour shapes or geometry of the component 1 are merely shown as examples and these will depend on the intended purpose or place of deployment and can be adapted to suit these.

The orthodontic component 1 is used in the field of orthodontics and is usually referred to as a “bracket”. It is primarily used to treat misaligned teeth. A bracket is referred to as self-alloying if it is able to retain the clamping wire in the retaining slot of its own accord without it being able to slip out of the retaining slot in the direction perpendicular to its longitudinal extension. By actively alloying is meant a bracket in which a frictional connection is generated between the clamping wire and bracket by a pressure applied to the clamping wire. For a long time, this has been done by providing rubber bands. Finally, by the expression passively alloying is meant the co-operation between the clamping wire and bracket whereby the clamping wire is guided in the retaining slot with a clearance. This method is usually selected at the start of the treatment. The expression actively self-alloying refers to the situation where the pressing force on the clamping wire is applied directly by a part of the bracket or an aid co-operating with the bracket, such as a rubber ring for example. Yet another option is to retain the clamping wire disposed in the retaining slot more firmly against it by means of a rubber-type clamping element co-operating with the hooks on the component 1, which may also be referred to as “wings”. By applying tension from one side, the tooth to be treated can be turned, for example.

The orthodontic component 1 comprises a main body 2 which, in terms of its three-dimensional shape, to put it simply, is defined by a visible surface 3 directed towards an observer, a base surface 4 facing away therefrom and side faces 5 to 8 extending between these two. The base surface 4 is used to fit the main body 2 on a tooth 9 with a tooth surface 10 illustrated in a very simple format. Also illustrated in a simple format is a retaining slot 11, which is provided in the region of the visible surface 3 as a means of accommodating a clamping wire 12. The retaining slot 11 in this instance extends from the visible surface 3 into the main body 2 and in the direction towards the base surface 4 as well as between the two oppositely lying side faces 5, 6.

The base surface 4 of the main body 2 is used as a means of fitting the component 1 on the tooth surface 10 of the tooth 9 and connecting it to it by a connecting means 13, such as an adhesive or similar for example. The connecting means 13 is illustrated on a simplified basis by means of dots. In order to make the surface area of the connection bigger in the region of the base surface 4, at least one but preferably several groove-shaped recesses 14 may be provided in the main body 2, recessed into the base surface 4. The recesses 14 extend from the base surface 4 in the direction towards the visible surface 3. The longitudinal extension of the groove-shaped recess 14 in this embodiment extends continuously between the two side faces 5 and 6.

In the embodiment illustrated as an example here, the groove-shaped recess 14 has an approximately mushroom-shaped cross-section as viewed in axial section. A boundary line 15 of the groove-shaped recess 14 as viewed in axial section is exclusively made up of arcuate portions 16 disposed one after the other in the circumferential direction.

The retaining slot 11 is provided in the main body 2 as a means of accommodating the clamping wire 12 and at least one retaining means 17 is provided in addition which, when the clamping wire 12 is in the position inserted in the retaining slot 11, is intended to prevent it from undesirably moving out or sliding out. In its cross-section, in other words as viewed in the direction of its longitudinal extension, the retaining slot 11 has a groove width 18. The or several retaining means 17 extends or extend into the retaining slot 11 leaving a gap width 19 between them when they are in the non-deformed position. The gap width 19 left free is selected so that it is shorter than the groove width 18 accommodating the clamping wire 12. In any event, the gap width 19 is selected so that the inserted clamping wire 12 can not move out of the retaining slot 11 in the direction perpendicular to the longitudinal extension of the clamping wire 12 or retaining slot 11.

The retaining means 17 is provided in the form of at least one catch projection 20. In the embodiment illustrated as an example here, the catch projection or projections 20 is or are an integral part of the main body 2 and is or are formed by providing a longitudinal slot 21 in the region of the retaining slot 11. The longitudinal slot 21 extends from a side wall 22 of the retaining slot 11 into the main body 2. The retaining slot 11 is also bounded by a groove base 23 on the side facing the base surface 4. The side walls 22 and the groove base 23 therefore define the retaining slot 11 in terms of its cross-sectional shape and size. The cross-section of the clamping wire 12 illustrated in this instance is a rectangular cross-section, although any other cross-sections could be used, for example round, oval, square, polygonal and such like. Depending on the desired application or treatment procedure, suitable clamping wires 12 with the appropriate cross-sections will be selected.

In the situation illustrated here, a rectangular cross-section has been chosen for the clamping wire 12. The width of the clamping wire 12 approximately corresponds to the groove width 18 so that it can move into a position lying against the two side walls 22 of the retaining slot 11. A height of the clamping wire 12 in this instance is selected so that the clamping wire 12 is able to move into contact with the groove base 23 on the one hand and is supported on the catch projection or projections 20 on the other hand. This state is referred to as actively self-alloying and results in an adequate optimum transmission of force from the clamping wire 12 to the tooth 9. This enables sufficient retaining and orienting forces to be transmitted to the tooth 9. The clamping wire 12 is removed from the retaining slot 11 by what might be referred to as threading out or pulling it out in the direction of the longitudinal extension of the retaining slot 11. This means that there is no need for a deforming movement of the catch projection or projections 20. Once the clamping wire 12 has been removed, the individual teeth 9 can be checked and the clamping wire 12 can be fitted again to continue the treatment or replaced by another clamping wire 12 with a different cross-section.

If using a round clamping wire 12, it is preferable to opt for diameters of 0.014″ [in], 0.016″[in] or 0.018″ [in]. The reason why the units or measurements are given in inches [in] is because such clamping wires 12 are used in the USA and this measurement unit is used as standard. The clamping wire with a rectangular cross-section may have dimensions of 0.020″ [in] by 0.025″ [in].

In this example of an embodiment, the main body 2 has a foot or base part 24 and a retaining part 25. The foot or base part 24 is directed towards the tooth 9 and thus constitutes that portion of the orthodontic component 1 which is disposed immediately adjacent to the tooth 9. The retaining part 25 usually comprises a hook part 26. The hook part 26 is disposed in the region of the visible surface 3. Provided between the hook part 26 and the foot or base part 24 is another separate intermediate part 27. The retaining slot 11 is disposed in the region of the intermediate part 27 as viewed in cross-section.

The retaining part 25 is of a design integral with the base part 24 and forms part of a bending-resistant cross-section with the base part 24. The intermediate part 27 does not have to be deformed in order to insert the clamping wire 12 in the retaining slot 11 in this instance. As the clamping wire 20 is inserted in the retaining slot 11, it is exclusively the retaining means 17 provided in the form of catch projections 20 which are deformed. The catch projection 20 is disposed in the region of the visible surface and incorporated in the main body 2. As viewed in the direction of the longitudinal extension of the retaining slot 11, the catch projection or projections 20 is or are of a strip-shaped or lip-shaped design and may therefore have a whole range of different cross-sectional shapes. To make the movement of inserting the clamping wire 12 in the retaining slot 11 easier, it is preferable if the catch projection 20 is oriented at an angle as viewed in the direction of the longitudinal extension of the retaining slot 11, from the visible surface 3 to the groove base 23 of the retaining slot 11.

Due to this arrow-shaped arrangement of the two catch projections 20 directed towards one another, the movement needed to insert the clamping wire 12 is made easier on the one hand and it is also reliably prevented from sliding out of the retaining slot 11 on the other hand. If a stronger force is transmitted from the clamping wire 12 to the catch projection or projections 20 towards the direction facing away from the base surface 4—in other words away from the tooth 9—the catch projections 20 are able to deform towards one another, thereby further reducing the gap width 19 between the oppositely lying catch projections 20.

It is also of advantage if the catch projection or projections 20 is or are provided with stop surfaces 28 for the clamping wire 12 directed towards the groove base 23 and preferably oriented parallel with it as viewed in the direction of the longitudinal extension of the retaining slot 11. This enables the clamping wire 12 to be vertically locked by the groove base 23 and the stop surfaces 28.

As described above, the foot or base part 24 together with the retaining part 25 forms a bending-resistant body, and the elastic deformation of the retaining means 17 takes place exclusively between the latter and the hook part 26 in the region of a bending zone 29 illustrated on a simplified basis. As described above, the catch projection or projections 20 is or are provided in the form of the longitudinal slot 21 extending through the main body 2. The cross-section of the longitudinal slot 21 as viewed in the direction of the longitudinal extension of the retaining slot 11 is wedge-shaped and tapers from the side wall 22 of the retaining slot 11. It would also be possible for the longitudinal slot 21 and its cross-section as viewed in the direction of the longitudinal extension of the retaining slot 11 to be oriented so that it rises towards the visible surface 3. This results in an approximately V-shaped arrangement from the retaining slot 11 to the groove base 23.

As more clearly illustrated in FIG. 3, the clamping wire 12 is illustrated during the movement by which it is inserted in the retaining slot 11, during which the two catch projections 20 illustrated as an example here are in their deformed position or state. As also illustrated, the two catch projections 20 are deformed during the operation of inserting into the longitudinal slot 21, as a result of which the cross-section of the individual longitudinal slots 21 becomes smaller than when the catch projections 20 are in the non-deformed initial position. Once the clamping wire 12 has slid through the area of the narrower region formed by the catch projections, the clamping wire 12 reaches the position in the retaining slot 11 illustrated in FIG. 1.

However, it would also be possible to provide the retaining slot 11 with only a single retaining means 17 or catch projection 20 as a means of retaining the clamping wire 12 in the retaining slot 11. However, it is more practical to provide a catch projection 20 on each of the two side walls 22 of the retaining slot 11. This enables a smaller gap width 19 to be obtained for retaining the clamping wire 12 and also reduces the degree to which the catch projections 20 are deformed during the insertion movement.

To permit these elastic deformation movements of the retaining means 17 or catch projections 20, the main body 2 is made from an elastically deformable material, at least in the portion of its visible surface 3. This material is selected from the group comprising plastic, titanium, alloys with a titanium base, steel, stainless steel. It has proved to be of advantage to use polyurethane (PU) as the plastic because it can be manufactured with a very high degree of translucency to full transparency and with a high strength and abrasion resistance. Furthermore, this material is also very resistant to UV radiation and thus has a high resistance generally. The plastic may be a heat-deformable plastic or thermosetting plastic, for which polyaddition reactions terminate at least at body temperature. It is of advantage if the thermosetting plastic is highly cross-linked and is a polyurethane.

By translucency is meant the partial transparency of a body to light. There are many substances which are translucent because they are partially transparent to light but are not fully transparent. As distinct from transparency, translucency may be described as being transparent to light and transparency is transparent to images or sight. The higher the value selected for the translucency, the closer it comes to transparency. Transparency is the effect of transmission, and in terms of physics is understood as meaning the capacity of materials to allow electromagnetic waves to pass through them. If the waves—especially those of visible light—are not able to penetrate the material, the electrons of the medium absorb energy from the light wave and the waves are absorbed along the way. The material is therefore non-transparent. If, on the other hand, the waves penetrate the material or substance, no interaction occurs between the light and the atoms and the waves can also emit no energy to the atoms. The material is therefore transparent. Transparency is therefore not only a property of the material, it also relates to the electromagnetic wavelength in question. Transparency is therefore an optical property of a substance or material. Generally speaking, a substance or material is referred to as transparent or see-through if an object lying behind it is visible relatively clearly. Full transparency may also be referred to as glass clear.

In order to reduce visibility of the orthodontic component 1 when fitted on the tooth 9 for its intended purpose, it is of advantage if the material used to make the main body 2, especially if it is selected from a plastic, has an in-line translucency with a lower limit of 5% and an upper limit of 100% for a thickness of 0.5 mm. The in-line translucency is preferably selected so that it is between 70% and 100%. This means that incident light beams will be able to penetrate the orthodontic component 1 as far as the tooth surface 10 and will be reflected by it. A bream corresponding to the color of the tooth 9 will then be reflected by the component 1. Due to the fact that a small proportion of the light beam penetrating the component 1 is not reflected back from it, this will create the optical impression that the orthodontic component 1 has assumed the natural tooth coloring of the tooth 9 of every user. This offers a simple way of producing an orthodontic component 1 which is easy to produce on the one hand and is visually inconspicuous to its user on the other hand.

If the composition of the material of the component 1 is adjusted accordingly, the emission of reflected beams can be reduced or prevented. This will make the intrinsic coloring of the component 1 stand out in the foreground and it will be clearly optically visible compared with the tooth 9.

The degree to which a beam is able to penetrate a material is defined by the degree of translucency, which is the ratio of the intensity of the penetrating beam to the intensity of the incident beam, and is based on radiation at a certain wavelength and a sample of a given thickness.

These variables are expressed by the following formula

I/I₀=ke^{-ad}

in which
“I/I₀” stands for the intensities of the penetrating beam and the incident beam;
“d” stands for the thickness of the sample;
“a” stands for the coefficient of absorption and
“k” is a constant which can be derived from the refractive index of the material,
   the above being correlated with one another in a defined relationship. In this connection, the cone angle of the incident beam and the cone angle of the penetrating beam must also be quantified.

The degree of transmission can be measured with a laser beam with a wavelength of 0.63 mm, for example, in which case the cone angle of the incident beam is very close to zero. The cone angle of the penetrating beam used to determine the intensity of the penetrating beam may be 60°, for example. A degree of transmission, in other words an in-line translucency, can be defined in this manner.

In-line translucency can be determined with a Perkin-Elmer Lambda spectrophotometer, e.g. of the type 9UV/VIS/NIR, and the wavelength range may be between 400 nm and 800 nm.

The thickness of the sample is preferably 0.5 ±0.005 mm and it is necessary to provide a high-quality surface finish, in other words very fine polishing is necessary, in order to prevent the light being reflected due to irregularities in the surface of the sample, which can significantly impair the measurement results. In principle, allowance must be made for the fact that measuring in-line translucency is a difficult problem because the quantity of light with which a sample is irradiated is measured as a proportion of the quantity of light of a given wavelength emitted from the sample. The difference between these quantities of light is caused by the fact that irradiated light is deflected and hence scattered due to irregularities in the sample, such as grains, grain boundaries and such like. This deflection and scattering essentially depends on the size and shape of the irregularities and it becomes difficult to measure the distribution of light if its size falls within the range of the wavelength that was used for this measuring experiment. Consequently, every test sample must be made with two mutually plane-parallel surfaces which must be polished to a predefined surface roughness.

In order to measure in-line translucency, the sample is illuminated with a directed or parallel bundled light beam with low divergence, which is oriented perpendicular to the surface of the sample. A partial loss of irradiation intensity is incurred due to the transfer of the irradiation from air to the test sample due to the different refractive indices between air and the test sample. The light intensity penetrating the test sample is then deflected in different directions due to irregularities. This being the case, the permitted angle of incidence of the radiation by reference to the measuring device is a major factor in determining in-line translucency. The greater the permitted angle of incidence at the measuring device, the greater the in-line translucency measured for the same test sample.

Consequently, both the angle of incidence of the light beam directed onto the test sample and the exit angle of the light of the emitted light beam must be kept the same for all test samples.

For example, it is preferable to accept an angle of 3° as the angle of contact. In this respect, it is of advantage to use a beam with a width of 0.2 mm and a height of 0.5 mm directed onto the test sample and an aperture with a diameter of 1 mm respectively 0.5 mm.

It would also be possible to set the angle of incidence of the penetrating beam at approximately 60°.

The essential aspect is that the bracket will assume a color corresponding to that of the tooth lying underneath if translucency is very high, for example between 70% and 90% up to 100%, because a major part of the penetrating light hits the tooth perpendicularly and is reflected outwards from it so that to an observer, it is essentially only the color of the tooth that is visible and the orthodontic component 1 or bracket appears to assume the color of the tooth.

In the case of components which are very small relative to the objects lying behind them and whose color they are intended to assume, it is also possible to manage with an in-line translucency of 60%-80% or 30%-70% because a major part of the light reflected towards different sides and not in a straight direction is also reflected and the component additionally fitted will assume the color of the background and be virtually invisible.

Lower translucency values of 5% to 30%, for example, may be used to provide such components with an intrinsic color for example, in which case the amount of intrinsic coloring of the component will predominate in the eyes of the observer. Due to the low amount of light reflected from the background, the influence of the surface lying behind will be very slight and will be sufficient to compensate for any color nuances which occur, provided the correct color has been used for the bracket depending on the base material.

In the case of components 1 which are more or less adapted to the color of the background, a better result is achieved if the in-line translucency is between 10% and 35%. This ensures a good match between the color of the component and a color element of the main body.

If a completely clear glass or transparent component 1 is used, this also offers another advantage in that during the operation of fitting the component 1 on the tooth surface 10 of the tooth 9, the person performing the fitting has an unobstructed view through it onto the tooth surface 10. This enables the distribution of the connecting means 13 in the recesses 14 in the region of the base surface 4 described above to be controlled more effectively. In addition, it also makes curing of the connecting means 13 much easier if it is done by UV-light or similar electromagnetic waves because the waves or radiation are able to penetrate the material of the component 1. Uniform setting across the entire connecting surface of the main body 2 to the tooth 9 can be obtained, thus producing better results in terms of adhesion.

FIG. 4 illustrates another embodiment of the component 1 which may be construed as an independent embodiment in its own right, the same reference numbers and names being used to denote components that are the same as those described in connection with FIGS. 1 to 3 above. To avoid unnecessary repetition, reference may be made to the more detailed description given above in connection with FIGS. 1 to 3.

Due to the smaller dimensions of the retaining slot 11, the clamping wire 12 illustrated in it in FIG. 4 is shown in a position in which it is lying on only the groove base 23. The catch projections 20 with their gap width 19 between them in the operating position prevent the clamping wire 12 from unintentionally slipping out of the retaining slot 11, even with these dimensions. The clamping wire 12 is again inserted in the retaining slot 11 due to the elastic deformation of the catch projections 20 during the insertion operation in the manner described above.

The embodiments illustrated as examples represent possible variants of the orthodontic component 1, and it should be pointed out at this stage that the invention is not specifically limited to the variants specifically illustrated, and instead the individual variants may be used in different combinations with one another and these possible variations lie within the reach of the person skilled in this technical field given the disclosed technical teaching. Accordingly, all conceivable variants which can be obtained by combining individual details of the variants described and illustrated are possible and fall within the scope of the invention.

For the sake of good order, finally, it should be pointed out that, in order to provide a clearer understanding of the structure of the orthodontic component 1, it and its constituent parts are illustrated to a certain extent out of scale and/or on an enlarged scale and/or on a reduced scale.

Above all, the individual embodiments of the subject matter illustrated in FIGS. 1, 2, 3; 4; constitute independent solutions proposed by the invention in their own right. The objectives and associated solutions proposed by the invention may be found in the detailed descriptions of these drawings.

The objective underlying the independent inventive solutions may be found in the description.

### LIST OF REFERENCE NUMBERS

1 Component
2 Main body
3 Visible surface
4 Base surface
5 Side face
6 Side face
7 Side face
8 Side face
9 Tooth
10 Tooth surface
11 Retaining slot
12 Clamping wire
13 Connecting means
14 Recess
15 Boundary line
16 Arcuate portion
17 Retaining means
18 Groove width
19 Gap width
20 Catch projection
21 Longitudinal slot
22 Side wall
23 Groove base
24 Base part
25 Retaining part
26 Hook part
27 Intermediate part
28 Stop surface
29 Bending zone

1. Orthodontic component (1), in particular a bracket, with a main body (2) comprising a visible surface (3), a base surface (4) spaced at a distance apart from it and side faces (5 to 8) extending in between, and a groove-shaped retaining slot (11) is provided in the main body (2) for accommodating a clamping wire (12) and the retaining slot (11) extends from the visible surface (3) into the main body (2) in the direction towards the base surface (4) and between the two side faces (5 to 8), and with at least one retaining means (17) for the clamping wire (12) extending into the retaining slot (11), wherein the retaining means (17) is provided in the form of a catch projection (20) and it is formed by providing a longitudinal slot (21) in the main body (2), and the longitudinal slot (21) extends from a side wall (22) of the retaining slot (11) into the main body (2), and the catch projection (20) is therefore elastically deformable.

2. Orthodontic component (1) according to claim 1, wherein the catch projection (20) is disposed in the region of the visible surface (3).

3. Orthodontic component (1) according to claim 1, wherein the catch projection (20) is of a strip-shaped design.

4. Orthodontic component (1) according to claim 1, wherein the catch projection (20) is oriented at an angle in the direction of the longitudinal extension of the retaining slot (11) from the visible surface (3) to a groove base (23) of the retaining slot (11).

5. Orthodontic component (1) according to claim 1, wherein the catch projection (20) has a stop surface (28) for the clamping wire (12) oriented parallel with the groove base (23) as viewed in the direction of the longitudinal extension of the retaining slot (11).

6. Orthodontic component (1) according to claim 1, wherein the cross-section of the longitudinal slot (21) in the direction of the longitudinal extension of the retaining slot (11) tapers in a wedge shape from the side wall (22) of the retaining slot (11).

7. Orthodontic component (1) according to claim 1, wherein the cross-section of the longitudinal slot (21) in the direction of the longitudinal extension of the retaining slot (11) rises from the side wall (22) of the retaining slot (11) to the visible surface (3).

8. Orthodontic component (1) according to claim 1, wherein the catch projection (20) is deformed into the longitudinal slot (21) during the operation of inserting the clamping wire (12) in the retaining slot (11).

9. Orthodontic component (1) according to claim 1, wherein a catch projection (20) is provided on each of the two side walls (22) of the retaining slot (11).

10. Orthodontic component (1) according to claim 1, wherein the main body (2) is made from an elastically deformable material at least in the area of its visible surface (3).

11. Orthodontic component (1) according to claim 10, wherein the material is selected from the group comprising plastic, titanium, alloys with a titanium base, steel, stainless steel.

12. Orthodontic component (1) according to claim 11, wherein the plastic is a heat deformable or thermosetting plastic for which polyaddition reactions terminate at least at body temperature.

13. Orthodontic component (1) according to claim 12, wherein the thermosetting plastic is highly cross-linked and is a polyurethane.

14. Orthodontic component (1) according to claim 11, wherein the plastic of the main body (2) has an in-line translucency of between 70% and 100% for a thickness of 0.5 mm.
